(19) United States
(12) Patent Application Publication
(10) Pub. No.: US 2026/0116114 A1
(43) Pub. Date: Apr. 30, 2026

(54) OPTICAL SECURITY COMPONENTS VISIBLE IN TRANSMISSION, MANUFACTURE OF SUCH COMPONENTS AND SECURE OBJECTS EQUIPPED WITH SUCH COMPONENTS

(71) Applicants: SURYS, Bussy Saint Georges (FR); UNIVERSITE DE TECHNOLOGIE DE TROYES, Cedex Troyes (FR)

(72) Inventors: Sania Chibli, Bussy-Saint-Georges (FR); Soukaina Es-Aidi, Bussy-Saint-Georges (FR); Anna Rumyantseva, Troyes (FR); Hind Kadiri, Troyes (FR); Sylvain Blaize, Troyes (FR)

(73) Assignees: SURYS, Bussy Saint Georges (FR); UNIVERSITE DE TECHNOLOGIE DE TROYES, Cedex Troyes (FR)

(21) Appl. No.: 19/144,235

(22) PCT Filed: Dec. 22, 2023
(86) PCT No.: PCT/EP2023/087741

§ 371 Date: Jun. 27, 2025

(30) Foreign Application Priority Data
Dec. 30, 2022 (FR) FR2214722

(51) Int. Cl. B42D 25/328; B42D 25/21; B42D 25/29; B42D 25/373

(52) U.S. Cl. CPC B42D 25/328; B42D 25/21; B42D 25/29; B42D 25/373

(57) ABSTRACT

An optical security component for authentication in transmission may include a layer of dielectric material, which is transparent in the visible. The optical security component may further include a diffractive structure patterned in the layer and a metal layer at least partially covering the diffractive structure. The diffractive structure may include a pattern forming a symmetrical one-dimensional periodic undulation that forms a diffraction grating producing a diffractive effect in reflection of order 1 and of order −1. For each period of the pattern, defined between two extrema of the undulation, the thickness of the metal layer, defined in a direction perpendicular to the plane of the component, is variable between a minimum value strictly less than 10 nm and a maximum value between about 10 nm and about 100 nm. The metal may be distributed asymmetrically, so as to produce a color effect visible in transmission.

### TECHNICAL FIELD OF THE INVENTION

The present description relates to the field of security markings. More particularly, it relates to optical security components that are visible in transmission, for verifying the authenticity of an object, for example a valuable product or document, for example an identity document or a banknote, to a process for manufacturing such a component and to a secure object equipped with such a component.

### PRIOR ART

Many technologies for authenticating documents or products, and in particular for securing documents such as valuable documents, banknotes, passports or other identity documents, are known. These technologies aim to produce optical security components the optical effects of which, as a function of observation parameters (orientation of the component with respect to the observation axis, position and dimensions of the light source, etc.), adopt characteristic and verifiable configurations. The general goal of these optical components is to generate novel and distinctive optical effects, using physical configurations that are difficult to reproduce. Among these components, DOVIDs (DOVID standing for Diffractive Optical Variable Image Device) are optical components that produce diffractive, variable images commonly called holograms.

More precisely, the present description focuses on optical security components exhibiting, in transmission, optical color effects that are noteworthy and distinct from optical effects in reflection.

Inspection in transmission is in particular used to verify valuable documents, for example banknotes, which to this end have an area that is empty and/or partially transparent or scattering, or passports, in which a page containing data relating to the bearer is provided with a transparent window. The optical security component may for example take the form of a security thread, of a security strip, or of a patch, which is intended to be seen from above, which is at least partially superposed on the see-through area, and which may be positioned on the surface or in the thickness of the document.

Plasmon-resonance-based optical security components that exhibit noteworthy optical color effects in transmission are known. Such components are for example described in patent application US2010/0307705 [Ref. 1]. The optical security component described in [Ref. 1] comprises, on a transparent substrate, a metal structure forming a periodic pattern of sub-wavelength period, the pattern having a rectangular profile and being integrated between a layer of an embossing lacquer and a layer of a protective lacquer. The metal structure is obtained by evaporation of a thin layer of metal on the layer of lacquer after embossing. By varying the evaporation angle of the metal, a sub-wavelength grating having an asymmetric profile may be obtained. The spectral characteristics in transmission and in reflection of the plasmon-resonance-based component thus obtained depend on the evaporation angle of the metal, this making it possible to design optical security components having different color effects in transmission and in reflection.

A plasmon-based optical security component exhibiting noteworthy color effects in transmission is also known (see patent application WO2012136777 [Ref. 2]). The optical component described in [Ref. 2] comprises two layers of transparent dielectric material, and a metal layer that is arranged between said layers of dielectric material to form two dielectric-metal interfaces, and that is structured to form on at least part of its surface undulations capable of coupling surface-plasmon modes supported by said dielectric-metal interfaces to an incident light wave. The undulations are arranged in a first coupling zone in a first main direction and in at least a second coupling zone different from said first coupling zone in a second main direction substantially perpendicular to the first main direction, said metal layer being continuous in each of said coupling zones. Such a component exhibits an extraordinary transmission effect in a spectral band centered on a wavelength defined by the characteristics of the undulations of the coupling zones, and to an observer, variations in color with the angle of observation of the component that differ depending on the coupling zone, allowing easy and reliable authentication of the security component.

In the two aforementioned references, the physical mechanism involved is a plasmon-resonance mechanism that is very sensitive to polarization. In particular, only the TM component of the incident electromagnetic field is coupled to the plasmon mode. Therefore, when these optical security components are illuminated with unpolarized light, the color effects observed in transmission are not particularly intense.

Moreover, optical security components observable in transmission are also known that employ resonance mechanisms in a layer of dielectric material rather than in a metal layer.

Such optical security components are for example described in patent application EP 2264491 [Ref. 3] or in the article by M. T. Gale et al. [Ref. 4] and are known as zero-order diffractive filters (ZOFs) or guided-mode resonance filters. The physical mechanism is based on resonant reflection of a guided mode in the high-index dielectric layer. In practice, the spectrum in transmission of such a resonant filter is the complement of the spectrum in reflection.

However, transmission in such a component remains high at all wavelengths and the optical effect in transmission therefore does not appear highly colored to an observer.

The present patent application describes an optical security component with an original structure making it possible to obtain, in transmission, both noteworthy optical color effects and a very good luminous intensity.

### SUMMARY OF THE INVENTION

In the present description, the term “comprise” means the same thing as “include”, “contain”, and is inclusive or open and does not exclude other elements that are not described or shown.

Furthermore, in the present description, the term “about” or “substantially” means the same thing as “having a margin of less than and/or greater than 10%, for example 5%” of the respective value.

According to a first aspect, the invention relates to an optical security component for securing an object, for example a valuable document, for example an identity document or a banknote, configured for authentication in transmission, with the naked eye.

The optical security component according to the first aspect comprises:
a first layer of dielectric material, which first layer is transparent in the visible;
at least a first diffractive structure patterned in said first layer;
a metal layer at least partially covering said first diffractive structure, and having a spectral band of reflection in the visible; and wherein:
   said first diffractive structure comprises, in a first region, at least a first pattern forming a first symmetrical one-dimensional periodic undulation having a first pitch between about 400 nm and about 900 nm, and a first depth, said first undulation being configured to form a diffraction grating producing, after deposition of the metal layer, a diffractive effect in reflection of order 1 and of order −1 in a wavelength range between 400 nm and 700 nm;
   for each period, defined between two extrema, of said first undulation, the thickness of the metal layer, defined in a direction perpendicular to the plane of the component, is variable between a minimum value strictly less than 10 nm and a maximum value between about 10 nm and about 100 nm, and the metal is distributed asymmetrically, so as to produce a color effect visible in transmission.

In the present description, a layer that is transparent in the visible is defined to be a layer having a transmittance of at least 70% and preferably of at least 80% at a wavelength in the visible, i.e. a wavelength between about 400 nm and about 700 nm. A transparent layer thus makes it possible to observe with the naked eye layers located under the transparent layer.

In the context of an undulation, the term “depth” is understood to mean a distance between a lowest level of the structure forming the undulation and a highest level, this distance being measured along an axis perpendicular to a plane of the component.

In the present description, a one-dimensional periodic undulation is a periodic structure with a profile that is continuously variable in a single direction, called the direction of variation of the profile, i.e. a structure having a height that varies according to a continuously variable and periodic function. A symmetrical one-dimensional periodic undulation is a one-dimensional periodic undulation that comprises, for each period of the undulation defined between two extrema of the undulation, at least one plane of symmetry perpendicular to a plane of the component and perpendicular to the direction of variation of the profile.

According to one or more examples of embodiment, the profile of the symmetrical periodic undulation is a sinusoidal or pseudo-sinusoidal profile, i.e. a profile comprising a sum of sinusoids of different periods, these examples being non-limiting.

According to the present description, said first periodic undulation has a first pitch and a first depth that are configured to form a diffraction grating defined so as to produce, after deposition of the metal layer, a diffractive effect in reflection at least of order 1 and of order −1 in a wavelength range between 400 nm and 700 nm. The symmetry of the periodic undulation makes it possible to increase the effectiveness of the diffractive effect of order 1 and of order −1. The first pitch is between about 400 nm and about 900 nm, advantageously between about 450 nm and about 750 nm, and advantageously between about 500 nm and about 700 nm.

Moreover, according to the present description, for each period, defined between two extrema, of the first undulation, the thickness of the metal layer, defined in a direction perpendicular to the plane of the component, is variable between a minimum value strictly less than 10 nm and a maximum value between about 10 nm and about 100 nm, and the metal is distributed asymmetrically, so as to produce a color effect visible in transmission.

An asymmetrical distribution of the metal means that for each period defined between two extrema, there is no plane of symmetry of the metal layer that is perpendicular to a plane of the component and perpendicular to the direction of variation of the profile of the undulation.

The applicant has demonstrated that noteworthy color effects can be obtained with such an optical security component, in which the profile of the diffractive structure is symmetrical but the metal distribution asymmetrical with, within a given period defined between two extrema, a region with very little or even no metal, and a region with a greater thickness of metal. Such an optical security component exhibits, in transmission, noteworthy and luminous color effects.

Moreover, the applicant has shown that during an observation in transmission, with the angle of observation varied by tilting the component about an axis perpendicular to the direction of variation of the profile of the undulation, an observer is able to observe a color change that is asymmetrical with respect to the direction normal to the plane of the component. Such a noteworthy and distinctive effect allows more secure authentication with a strong technological barrier, because of the difficult nature of the design then the steps of mass production of the component, required to obtain the visual effect described above.

Generally, a rotation of the component about an axis contained in the plane of the component will be called a “tilting movement” of the component, or “rocking”.

Such an effect in transmission, which couples intense colors and luminous intensity, something that is original in the security field, may in particular be explained, though this explanation is non-limiting, by resonant transmission resulting from a diffractive effect combined with excitation of surface modes. This luminous efficacy is a result of an effect visible both in TE mode and in TM mode, in contrast to the plasmonic resonances generated in known prior-art optical security components, by means of diffractive sub-wavelength structures, with periods generally between 200 nm and 400 nm.

According to one or more examples of embodiment, the ratio between the maximum value of the thickness of the metal layer and the minimum value of the thickness of the metal layer is greater than or equal to about 5, advantageously greater than or equal to about 10, and advantageously greater than or equal to about 15. With a high ratio between the maximum value of the thickness of the metal layer and the minimum value of the thickness of the metal layer, the asymmetry in the distribution of the metal layer is great and the optical color effect is even more pronounced.

According to one or more examples of embodiment, said metal layer results from evaporation of metal onto said first structure with a non-zero evaporation angle, for example an evaporation angle between about 25° and about 70°. For a known undulation profile, for example a sinusoidal or quasi-sinusoidal profile, it is possible to choose the evaporation angle of the metal in order to obtain the desired asymmetry in the distribution of the metal layer.

According to one or more examples of embodiment, said first diffractive structure comprises, in a second region, at least a second pattern forming a second symmetrical one-dimensional periodic undulation having a direction of variation of its profile parallel to the direction of variation of the profile of the first undulation, having a depth identical to that of the first undulation and having a pitch different from that of the first undulation, the first pattern and second pattern having outlines that are recognizable when observed with the naked eye, in transmission.

In such a component, because of the different pitches of the undulations, during observation in transmission of zero order, different colors will be observed for each pattern. Moreover, by tilting the component about an axis perpendicular to the direction of variation of the profile of the undulations, a variation in color will be observed for each pattern, with, noteworthily, an asymmetry in the observation of the colors on either side of a position corresponding to an observation in a direction normal to the component.

According to one or more examples of embodiment, said first diffractive structure comprises, in a second region, at least a second pattern forming a second symmetrical one-dimensional periodic undulation having a direction of variation of its profile parallel to the direction of variation of the profile of the first undulation, having a pitch identical to that of the first undulation and having a second depth strictly less than the first depth of the first undulation, the first pattern and second pattern having outlines that are recognizable when observed with the naked eye, in transmission.

In such a component, because of the different depths of the undulations, it will be possible to generate patterns that are colored in transmission and patterns that are not colored.

Specifically, in particular when the metal layer results from evaporation under vacuum with a non-zero evaporation angle, in the region where the undulation has a smaller thickness, the asymmetry of the metal layer will not be as pronounced.

According to one or more examples of embodiment, said first diffractive structure further comprises a microscopic pattern comprising a set of facets of microscopic dimensions, and of variable slopes, the first pattern modulating the microscopic pattern.

According to one or more examples of embodiment, the optical security component further comprises at least a second structure patterned in said first layer, said second structure for example being chosen from: a scattering structure, a holographic structure, a diffracting structure of Alphagram® type.

According to a second aspect, the present description relates to a secure object, for example a valuable security document, comprising a substrate and an optical security component as claimed in any of the preceding claims, deposited on said substrate.

According to a third aspect, the present description relates to a process for manufacturing an optical security component according to any of the embodiments described above.

Generally, the present description relates to a process for manufacturing an optical security component for securing an object, for example a valuable document, for example an identity document or a banknote, configured for authentication in transmission, with the naked eye, the process comprising:
depositing a first layer of dielectric material on a carrier film, the first layer being transparent in the visible;
forming at least a first diffractive structure on said first layer,
depositing a metal layer at least partially covering said first diffractive structure, and having a spectral band of reflection in the visible, wherein:
   said first diffractive structure comprises, in a first region, at least a first pattern forming a first symmetrical one-dimensional periodic undulation having a first pitch between about 400 nm and about 900 nm, and a first depth, said first undulation being configured to form a diffraction grating producing, after deposition of the metal layer, a diffractive effect in reflection of order 1 and of order −1 in a wavelength range between 400 nm and 700 nm;
   for each period of said first pattern, a period being defined between two extrema, of the first undulation, the thickness of the metal layer, defined in a direction perpendicular to the plane of the component, is variable between a minimum value strictly less than 10 nm and a maximum value between about 10 nm and about 100 nm, and the metal is distributed asymmetrically, so as to produce a color effect visible in transmission.

According to one or more examples of embodiment, said metal layer results from evaporation of metal onto said first structure with a non-zero evaporation angle, for example an evaporation angle between about 25° and about 70°.

### BRIEF DESCRIPTION OF THE FIGURES

Other features and advantages of the invention will become apparent on reading the following description, which is illustrated by the following figures:

FIG. 1A schematically illustrates a (partial) sectional view of one example of embodiment of a component according to the present description.

FIG. 1B schematically illustrates a (partial) sectional view of another example of embodiment of a component according to the present description.

FIG. 2 illustrates a number of examples of a first diffractive structure according to the present description with a first pattern M₁, the structure being covered with a metal layer arranged asymmetrically, in a security component according to the present description.

FIG. 3 illustrates, according to one example, an animation visible in reflection during a tilting movement of a secure object equipped with an optical security component according to one example according to the present description.

FIG. 4 illustrates, according to one example, an animation visible in transmission during a tilting movement of a secure object equipped with an optical security component similar to the one illustrated in FIG. 3.

FIG. 5A illustrates parameters in an optical security component according to the present description;

FIG. 5B shows a calculated curve of transmittance as a function of wavelength in one example of an optical security component such as illustrated in FIG. 5A illuminated at normal incidence with TE polarized light and comparative transmittance curves.

FIG. 5C shows a calculated curve of transmittance as a function of wavelength in one example of an optical security component such as illustrated in FIG. 5A illuminated at normal incidence with TM polarized light and comparative transmittance curves.

FIG. 5D shows a calculated curve of transmittance as a function of wavelength in one example of an optical security component such as illustrated in FIG. 5A illuminated at normal incidence with unpolarized light and comparative transmittance curves.

FIG. 6A schematically illustrates a (partial) sectional view of an optical security component with a diffractive structure comprising a first pattern according to the present description in first regions and unstructured regions between the first regions.

FIG. 6B illustrates an optical effect visible in transmission of a high-definition colored image with a tiltwise-variable color obtained with an optical security component such as schematically shown in FIG. 6A.

FIG. 7 shows calculated curves of transmittance as a function of wavelength in one example of an optical security component according to the present description, for various tilt values.

FIG. 8A, schematically illustrates a (partial) sectional view of an optical security component with a diffractive structure comprising, in first regions, a first pattern according to the present description, and in second regions, a second pattern formed of undulations identical to those of the first pattern but shallower, and illustrates a visual effect in reflection in such a component.

FIG. 8B illustrates a visual effect in transmission in the optical security component shown in FIG. 8A.

FIG. 8C illustrates an optical effect visible in transmission of a high-definition colored image with a tiltwise-variable color obtained with an optical security component such as schematically shown in FIG. 8A.

FIG. 9A schematically illustrates a (partial) 3D view of one example of an optical security component in which a first pattern according to the present description modulates a second pattern formed by facets of microscopic dimensions.

FIG. 9B illustrates an optical effect visible in transmission in an optical security component of the type illustrated in FIG. 9A.

FIG. 9C shows schematics illustrating a visual animation visible in transmission obtained by means of an optical security component of the type illustrated in FIG. 9A.

### DETAILED DESCRIPTION

In the figures, the elements have not been shown to scale for the sake of legibility.

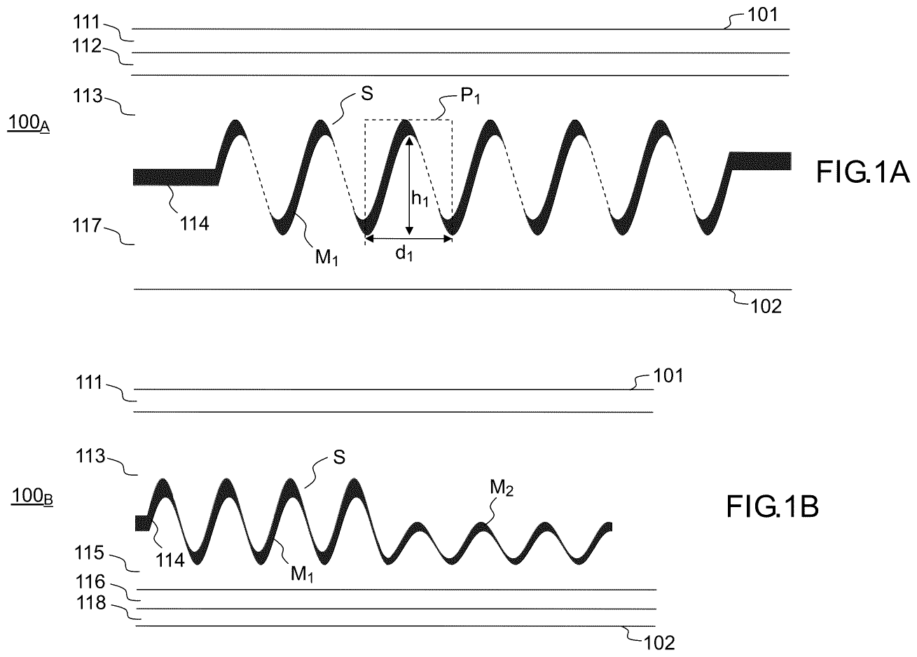

FIG. 1A and FIG. 1B show schematically and via (partial) sectional views two examples of optical security components according to the present description.

The optical security component 100A shown in FIG. 1A is, for example, an optical security component intended to be transferred to a document or product with a view to increasing its security. In this example, it comprises a carrier film 111, for example a polymer film, for example a film made of polyethylene terephthalate (PET) with a thickness of a few tens of microns, and more generally between about 10 μm and about 50 μm, and a detachment layer 112, which is for example made of natural or synthetic wax. The detachment layer allows the polymer carrier film 111 to be removed after the optical component has been transferred to the product or document the security of which is to be increased. The optical security component 100A moreover comprises a first layer 113 of dielectric material, having a first refractive index n₁ and at least a first diffractive structure S, which comprises at least a first pattern M₁, said first pattern M₁ forming a one-dimensional periodic undulation, which is embossed in said first layer 113 and which will be described in greater detail below.

In the example of FIG. 1A, the optical security component 100_{A} also comprises a metal layer 114 covering said first structure S, and having a spectral band of reflection in the visible. The metal layer for example comprises a metal chosen from the group containing aluminum, silver, copper, chromium and an alloy of the aforementioned metals.

The optical security component moreover comprises one or more optional layers that are optically non-functional but adapted to the application.

For example, in the example of FIG. 1A, the optical security component further comprises a layer of adhesive 117, for example a layer of heat reactivatable adhesive, for transferring the optical security component to the product or document.

In practice, as will be detailed below, the optical security component may be manufactured by stacking the layers on the carrier film 111; the component is then transferred, by means of the adhesive layer 117, to a document/product the security of which is to be increased.

Optionally, the carrier film 111 may then be detached, for example by means of the detachment layer 112.

An optical security component according to the present description generally comprises a first face 101 for observing in reflection the optical security component, which face is located in the example of FIG. 1A on the side of the first layer 113 opposite the patterned face of the layer 113, and a second face 102 for observing in transmission the optical security component, which face is located in the example of FIG. 1A on the same side as the patterned face of the first layer 113.

The optical security component 100B shown in FIG. 1B is, for example, an optical security component intended to increase the security of banknotes; it is for example a question of part of a security thread intended to be integrated into the paper during the manufacture of the note, or of a laminated strip covering a window in the paper, or of a patch. In this example, the component 100B comprises, as above, a carrier film 111 (thickness generally between about 10 μm and about 50 μm) which will also serve as a protective film for protecting the security thread, and, as in the example of FIG. 1A, a first layer 113 of dielectric material having a first refractive index n₁, at least a first diffractive structure S embossed in said first layer 113, and a metal layer 114 covering said first structure S and having a spectral band of reflection in the visible.

In the example of FIG. 1B, the first diffractive structure S comprises a first pattern M₁ and a second pattern M₂ each forming one one-dimensional periodic undulation, the undulations being of different depths, the first and second patterns being embossed in said first layer 113 in such a way as to form specific visual effects which will be described in greater detail below.

The optical security component 100B moreover comprises, in the example of FIG. 1B, a set of optional layers 115, 116, 118. The (optional) layer 115 is for example a transparent layer 115 of dielectric material; the (optional) layer 116 is for example a security layer 116, for example a discontinuous layer with a specific pattern printed locally with a UV ink to produce an additional marking that can be inspected by eye or by machine; and the (optional) layer 118 is for example a transparent protective layer, for example a second polymer film or a varnish. In the case of a laminated strip, the layer 118 may be an adhesive layer. As in the previous example, manufacture may be carried out by stacking the layers on the carrier film 111. The dielectric layer 115 and the security layer 116 may form only a single layer. The protective layer (or adhesive layer) 118 and the layer 115 may also form one and the same layer.

It will be obvious to anyone skilled in the art that other optically non-functional layers may be added, depending on the needs of the application, in each of the examples shown in FIGS. 1A and 1B, and that the variants of embodiment shown in FIGS. 1A and 1B may be combined.

It will be noted that the additional optically non-functional layers, for example the layer 117, or the layers 115, 116, 118, are transparent in the visible spectrum, as is the intended end carrier, so that the optical security component may be authenticated from both sides, i.e. by observing both its faces 101, 102, and in particular in transmission.

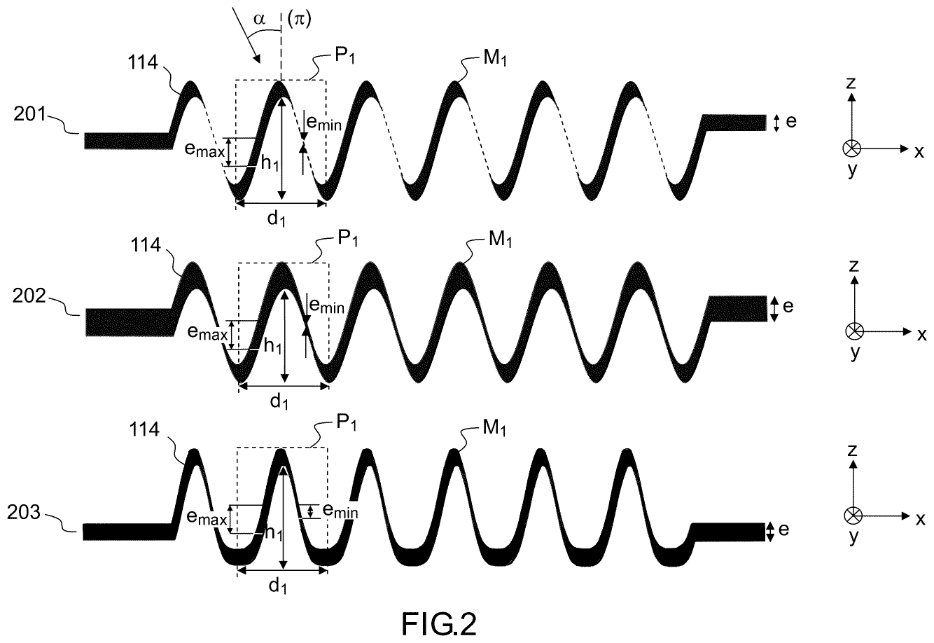

FIG. 2 illustrates in more detail examples 201, 202, 203 of a first diffractive structure according to the present description with a first pattern M₁ forming a symmetrical one-dimensional periodic undulation, the first structure being covered with a metal layer 114. The schematics illustrate partial sectional views of a component, the sectional views being of an (xz) plane perpendicular to an (xy) plane of the component and containing the direction (x) of variation in the profile of the undulation.

In the three examples illustrated in schematics 201, 202, 203, the first pattern consists of a one-dimensional periodic undulation with a period (or pitch) d₁ and a profile height h defined along the z-axis perpendicular to the (xy) plane of the component. Such a periodic undulation is a periodic structure the profile of which, which is described by the height h, is continuously variable. Moreover, according to the present description, the profile is symmetrical, i.e. it comprises, as illustrated by way of example in schematic 201, for each period of the undulation defined between two extrema, at least one plane of symmetry π perpendicular to the (xy) plane of the component and perpendicular to the (x) direction of variation of the profile of the undulation.

In the examples illustrated in schematics 201 and 202, the profile of the undulation is substantially sinusoidal, i.e. it is patterned with as setting a sinusoidal function h(x) of form:

$$h ( x ) = \frac{{h}_{I}}{2} sin ( \frac{2 π x}{{d}_{1}} ) \qquad [ Math 1 ]$$

where d₁ is the period (or pitch), h₁ is the depth, and x is the coordinate along the (x) axis of variation in the profile of the undulation. The height h of the undulation is measured in the z-direction perpendicular to the plane of the component, with respect to a base plane parallel to the plane of the component.

In practice of course, during production of the component, for example in an embossing step, the profile may undergo deformation with respect to a perfect sinusoid.

Moreover, any other form of symmetrical periodic undulation is possible.

As illustrated in the example of schematic 203, the profile of the undulation may for example be substantially pseudo-sinusoidal, i.e. patterned with as setting a pseudo-sinusoidal function h(x) comprising a sum of sinusoidal functions, for example a sum of two sinusoidal functions, for example, as illustrated in schematic 203, a function h(x) of form:

$$h ( x ) = \frac{{h}_{1}}{2} sin ( \frac{2 π x}{{d}_{1}} ) + \frac{{h}_{1}}{8} sin ( \frac{4 π x}{{d}_{1}} \pm \frac{π}{2} ) \qquad [ Math 2 ]$$

In every case, the periodic and symmetrical undulation has a pitch d₁ between about 400 nm and about 900 nm, advantageously between about 500 nm and about 700 nm, and a depth h₁, in order to form a diffraction grating defined so as to produce, after deposition of the metal layer, a diffractive effect in reflection of order 1 and of order −1 in a wavelength range between 400 nm and 700 nm. The symmetry of the periodic undulation makes it possible to increase the effectiveness of the diffractive effect of order 1 and of order −1.

In examples of embodiment, a depth of the undulation is between about 60 nm and about 400 nm.

Moreover, according to the present description and as illustrated in examples 201-203, over a period P₁ of the first diffractive structure defined between two extrema, the thickness e of the metal layer, defined in a direction (z) perpendicular to the plane of the component, is variable between a minimum value strictly less than 10 nm and a maximum value between about 10 nm and about 100 nm, and the metal is distributed asymmetrically. An asymmetrical distribution of the metal means that for each period P₁ defined between two extrema, the metal layer has no plane of symmetry perpendicular to the (xy) plane of the component and perpendicular to the (x) direction of variation of the profile of the undulation.

According to examples of embodiment, such an asymmetrical distribution of the metal used to form the metal layer 114 is obtained by virtue of evaporation of metal onto the first structure with a predetermined evaporation angle α that depends on the profile of the undulation and on the minimum and maximum values sought for the thickness of the metal layer. The evaporation angle α is defined in the (xz) plane, i.e. the plane of FIG. 2, with respect to the (z) direction normal to the plane of the component, the (xz) plane being perpendicular to the (xy) plane of the component and containing the (x) direction of variation of the profile of the undulation.

Thus, for example, in the case of a sinusoidal or quasi-sinusoidal profile, with a period between about 400 nm and about 900 nm, and advantageously between about 500 nm and about 700 nm, and a depth between about 60 nm and about 400 nm, the evaporation angle may be between about 25° and about 70°. Of course, this range of values may be adjusted depending on the parameters of the undulation in order to obtain the desired thicknesses of metal and the corresponding visual effects, as will be explained in greater detail below.

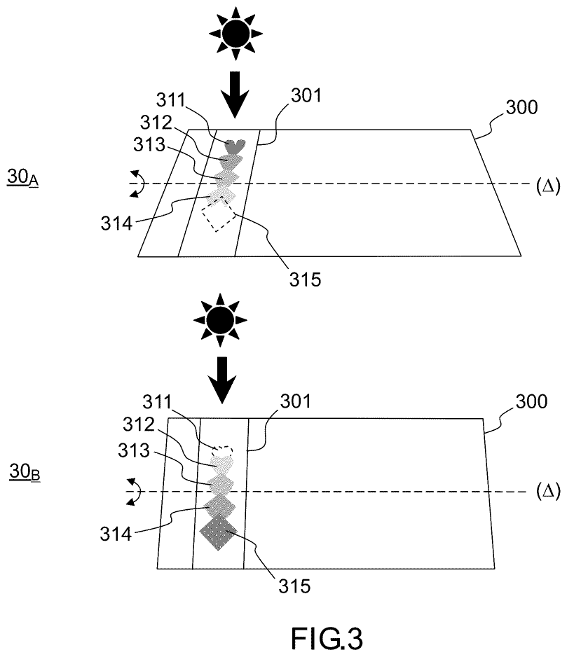

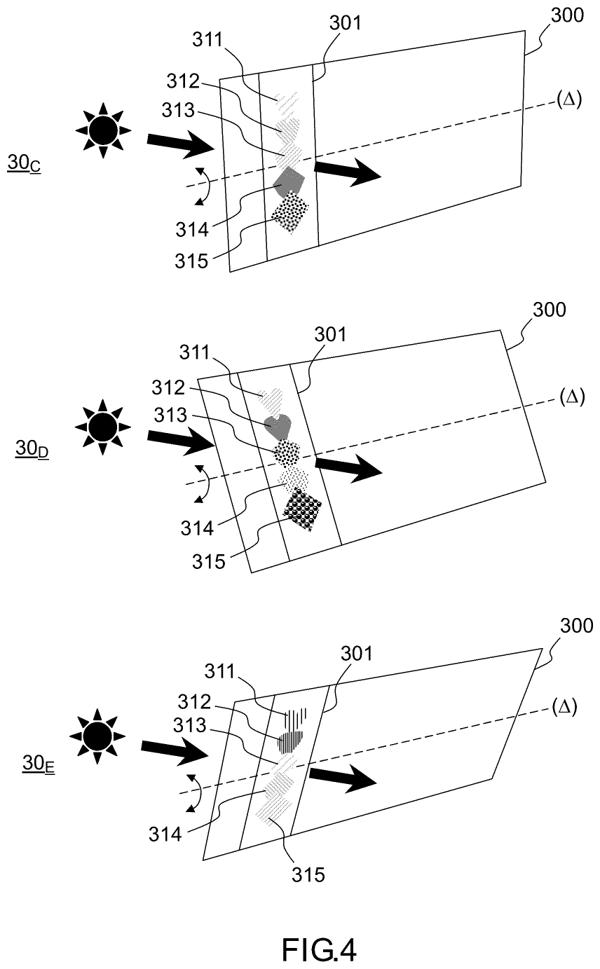

Methods other than oblique evaporation of the metal may be used to obtain an asymmetrical distribution of the metal on the first pattern, for example partial demetallization operations. FIG. 3 and FIG. 4 schematically illustrate visual effects obtained in reflection and in transmission with an optical security component according to the present description, respectively.

These figures show a secure object 300, for example a security document, on which an optical security component 301 is arranged, the optical security component for example taking the form of a security strip, for example one such as illustrated in FIG. 1B, the optical security component comprising at least a first structure according to the present description.

In this example, the first structure comprises in a first region a plurality of patterns the outlines of which have been indicated by the references 311-315 in the figures. The patterns are formed of respective symmetrical periodic one-dimensional undulations arranged in the same direction (parallel undulations), but for example having a different pitch. In each of the patterns, the undulation is configured to form a diffraction grating defined so as to produce, after deposition of the metal layer, a diffractive effect in reflection of order 1 and of order −1 in a wavelength range between 400 nm and 700 nm. Diffractive effects of higher orders may also be observed. However, as the pitch is different in each pattern, an observer will see in reflection at the first diffraction order, a different color for each of the patterns.

According to the present description, the first structure is covered with a metal layer (114, FIG. 1B), with an asymmetrical distribution of the metal.

As illustrated in FIG. 3, when an observer observes the secure object 300 in reflection in a given observation direction and applies a tilting movement about an axis (Δ) contained in the plane of the component and perpendicular to the direction of variation of the profile of the undulations ((y) direction, FIG. 2), a colorful iridescent animation is able to be seen. This colored animation, which is shown schematically in FIG. 3 between two tilted positions, respectively referenced 30A and 30B, comprises successive appearance of patterns in different colors. Specifically, because of the different pitch of the undulations in each of the patterns, for a given observation angle, only one or more of the patterns will be able to be seen via diffraction of order +1 or −1 and with a color that is pitch-dependent. By changing the angle of observation, other colors will appear for other patterns. The colors visible in reflection are the conventional colors of diffraction of order +1 or −1 resulting from the relationships governing the angular dispersion of gratings (Bragg's law).

It will be noted that because of the symmetry of the undulations and of the almost continuous presence of metal on the first structure, there is little effect on the observation of the diffraction of order +1 or −1, even if the distribution of metal is not symmetrical.

FIG. 4 schematically illustrates a second animation resulting from observation of the same secure object 300 but in transmission. Schematics 30c, 30p and 30; illustrate three tilted positions of the secure object 300 for the case where an observer is observing the secure object in transmission, the observation direction being coincident with the lighting direction, which has been represented in FIG. 4 by an arrow (observation of the zeroth order of diffraction).

As explained above, because of the asymmetrical distribution of the metal, intense and luminous colors are observed. Because of the different pitches of the undulations of the different patterns, the colors are different for each pattern. Moreover, by tilting the component about the axis (Δ) perpendicular to the direction of variation of the profile of the undulations, the color of each pattern may be made to vary.

Moreover, as illustrated in FIG. 4, when the secure object is tilted, an asymmetry is observed in the colors seen on either side of a position (3c) corresponding to an observation in a direction normal to the component (position of observation of the zeroth order). In other words, a given pattern is not seen to have the same color in tilted positions 30_{D} and 30_{E}, which correspond to symmetrical tilts of the secure object on either side of normal to the component.

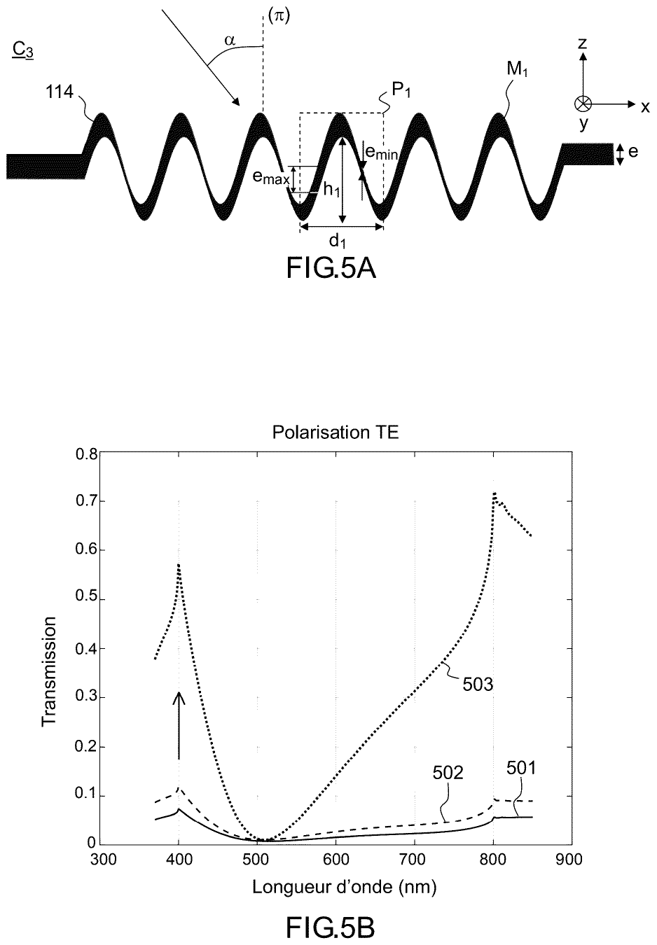

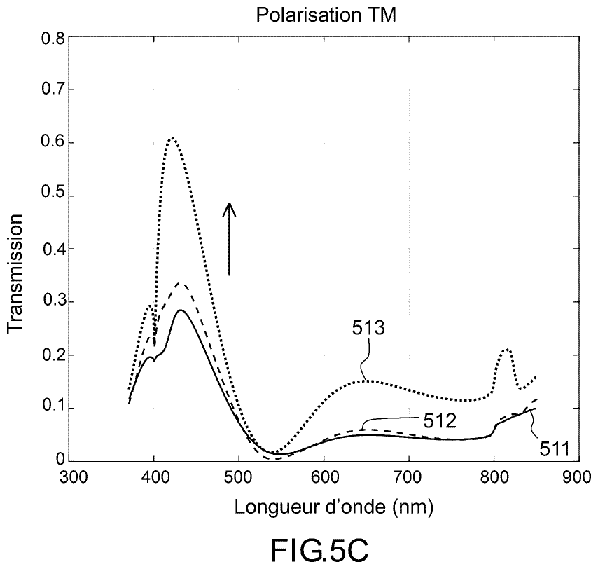

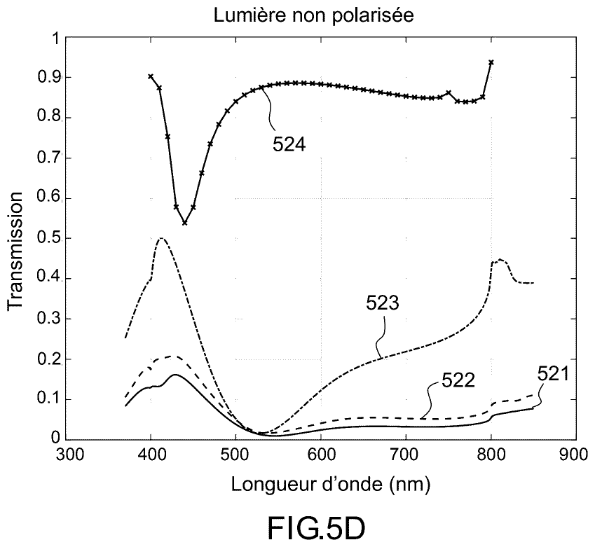

In the optical effect observed in transmission and illustrated by the schematics of FIG. 4, it is no longer a question, as was the case for observation in reflection, of an angular dispersion related to diffraction of orders +/−1 since the zeroth order is observed. The applicants attribute this original optical effect to a redistribution of the spectral energy density coupled to various diffraction orders as angle varies. In other words, energy that is not coupled to the order 0 is absorbed or radiated in other diffraction orders. This effect depends on angle of incidence, and is by nature asymmetrical. As will be explained with reference to FIG. 5A and FIG. 5B, this effect does not depend on polarization. This is an important difference with plasmonic colors.

FIG. 5B, FIG. 5C, FIG. 5D show, by way of illustration, curves of transmittance as a function of wavelength calculated for an optical security component such as shown in FIG. 5A (partial sectional representation) and comparative transmittance curves.

The curves were calculated by means of a known computational code using the RCWA method (RCWA standing for Rigorous Coupled Wave Approximation, see [Ref. 5]).

More precisely, FIG. 5B shows transmittance curves calculated in the case of optical security components illuminated at normal incidence with TE polarized light, FIG. 5C shows transmittance curves calculated in the case of optical security components illuminated at normal incidence with TM polarized light, and FIG. 5D shows transmittance curves calculated in the case of optical security components illuminated at normal incidence with unpolarized light.

The optical security component C₃ was such as illustrated in FIG. 5A and according to the present description and comprised a first pattern with a one-dimensional undulation, of sinusoidal profile, a pitch d₁ of 500 nm and a depth h₁ of 200 nm. The metal layer 114 resulted from evaporation of aluminum onto the structure with an angle α=40° and a deposition rate such that the equivalent thickness on a flat surface at normal incidence would be 30 nm. The metal layer 114 thus formed had an asymmetrical distribution of metal, in particular with segments of the sinusoid having a substantial thickness of metal, typically a maximum thickness of about 20 nm, and opposite segments of the sinusoid having a very small thickness of metal, typically a minimum thickness of about 2 nm.

As illustrated in FIG. 5B by the curve referenced 503, if such an optical security component is observed at normal incidence under TE polarized light, a strong wavelength-dependent transmission response is seen.

By way of comparison, curves 501 and 502 were calculated with an optical security component C₁ and with an optical security component C₂ that were identical to the component C₃ according to the present description except that, as regards curve 501, the metal layer was uniform, with a thickness equal to 30 nm, and, as regards curve 502, the metal layer had an asymmetrical distribution resulting from evaporation of aluminum with an evaporation angle α of 20°, respectively.

Curve 501 is a transmittance curve of an optical security component such as described in the prior art, for example such as described in [Ref. 2]. Since the evaporation angle is zero, the structure is very weakly transmissive.

Curve 502 is a transmittance curve of an optical security component with a metal layer that has an asymmetrical distribution of metal since the evaporation angle is not zero. However, the evaporation angle of 20° for a structure such as described with reference to FIG. 5A is small and the distribution of metal over one period of the undulation remains fairly uniform, and hence the effects in transmission are not as noteworthy.

Curves 513, 511 and 512 shown in FIG. 5C are transmittance curves calculated for TM polarization at normal incidence, for the optical security component C₃ according to the present description and for the optical security components C₁ and C₂ described above and introduced by way of comparison, respectively.

It is noteworthy that a strong wavelength-dependent transmission response is again observed for component C₃ according to the present description (curve 513).

Components C₁ and C₂ have a very weak transmission response to TM polarization (curves 511, 512 respectively).

FIG. 5D shows transmittance curves calculated for the components described above but this time under unpolarized light.

It may be seen that curve 523 calculated with the optical security component C₃ according to the present description has a strong transmission response that is also strongly wavelength-dependent. This is explained by the response of such a component both to TE and TM polarizations. In practice, this means that if the component is illuminated with white light, an intense and luminous color effect is obtained.

By way of comparison, curves 521 and 522 illustrate the transmittance curves calculated under the same conditions for the optical security components C₁ and C₂ described above. A very weak transmission response is observed.

Also by way of comparison, curve 524 illustrates a transmittance curve calculated under the same conditions for an optical security component C₄ comprising a first pattern identical to that of the optical security component C₃ (one-dimensional periodic undulation, period of 500 nm and depth of 200 nm) except that the metal layer has been replaced by a layer of high-index material with a thickness of 80 nm. Such an optical security component is according to the prior art, such as for example described in [Ref. 3] or [Ref. 4] (guided-mode resonance filter). Such a component behaves in transmission like a subtractive filter. As curve 524 shows, the transmittance is very high and the resulting color effect is therefore very luminous but the color is not very marked because transmittance remains high at all wavelengths.

The figures described above thus show that an optical security component according to the present description exhibits a noteworthy effect in transmission.

This noteworthy effect may be used to generate more complex visual effects or animations, as will be described with reference to the following figures.

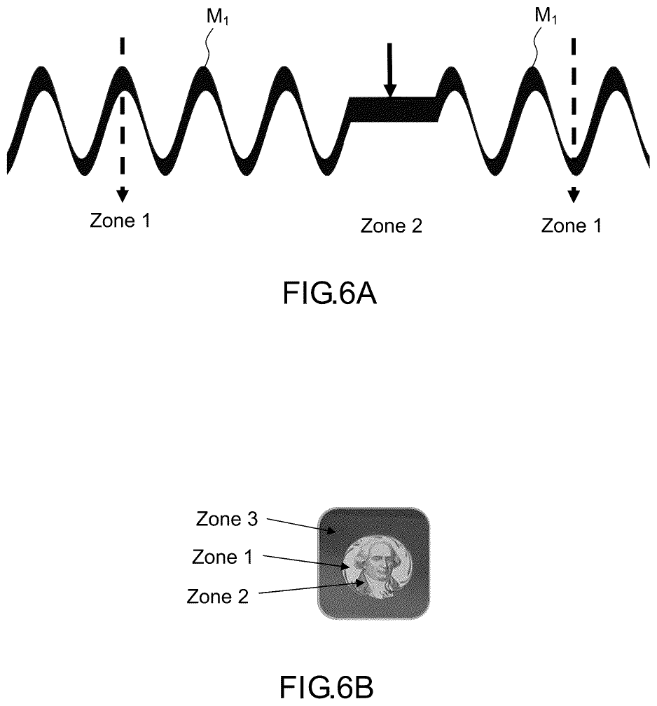

FIG. 6A illustrates a (partial) sectional view of an optical security component according to the present description, in which the first diffractive structure S comprises, in first regions (“Zone 1”), a first pattern M₁ according to the present description and such as for example described with reference to FIG. 2, and between these first regions, regions that are said to be unstructured (“Zone 2”).

FIG. 6B illustrates, observed in transmission, an optical security component in which the diffractive structure is designed, in the phase of embossing of the embossing layer (113, FIG. 1A and FIG. 1B), to generate a high-definition image, i.e. an image with a resolution greater than 2500 dots per inch (dpi) (i.e. a pitch between two points less than about 10.1 μm) and preferably a resolution greater than 3000 dpi (i.e. a pitch between two points less than about 8.5 μm). The diffractive structure comprises, in the example of FIG. 6B, a structure of the type schematically shown in FIG. 6A, with first regions comprising the first pattern M₁ (Zone 1), and unstructured regions (Zone 2, Zone 3). In the regions structured with the pattern M₁, the optical security component appears colored with a color that depends, as explained above, on the first pattern, on the metal layer and on the tilt angle. In contrast, in the unstructured regions, the metal layer is thick, there is no resonant effect and the transmittance is almost zero. Thus, as illustrated in FIG. 6B, an observer sees, in transmission, a colored image with a bright and luminous color, and a very good definition.

By varying the tilt angle about a direction Δ parallel to the direction of the undulations, a variation in the color in transmission is observed.

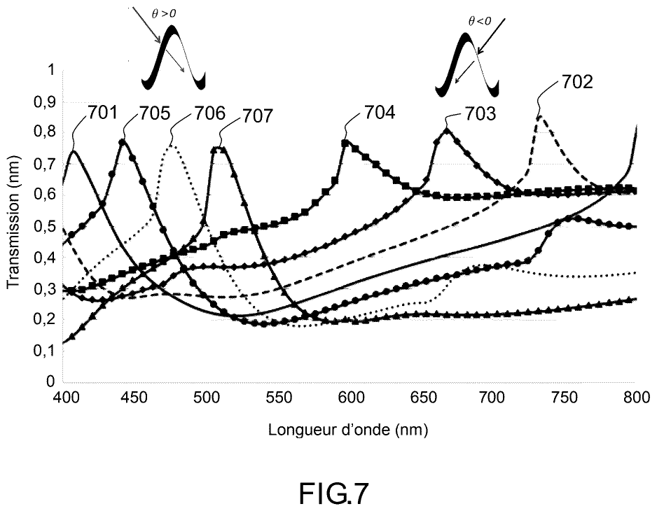

FIG. 7 shows, by way of illustration, transmittance curves calculated for an optical security component according to the present description. More precisely, for the simulation, the first pattern consisted of a one-dimensional undulation, of sinusoidal profile, with a pitch equal to 500 nm and a depth equal to 200 nm. The metal layer resulted from evaporation of aluminum onto the structure with an angle α=60° and a deposition rate such that the equivalent thickness on a flat surface at normal incidence would be 30 nm.

Curves 701, 702, 703, 704, 705, 706, 707 are calculated curves of transmittance as a function of wavelength for angles of incidence θ=0° (normal incidence), θ=−5°, θ=−10°, θ=−15°, θ=+5°, θ=+10°, and θ=+15°, respectively. It is noteworthy that not only does the spectrum vary significantly with wavelength, this resulting in a change in color with tilt, but also the spectrum is not symmetrical on either side of normal incidence. In other words, on either side of normal incidence, an observer does not see the same colors, this reinforcing the authenticity of the document.

Returning to the example of an optical security component as illustrated in FIG. 6A and in FIG. 6B, an observer will thus be able to authenticate the component in transmission, by virtue of observation of an intense and unusual colored visual effect that is variable as a function of tilt angle and asymmetrical on either side of normal incidence.

It will be noted that if the observer observes the same component in reflection, she or he will also be able to observe a colored image with a color that varies with tilt angle, the color resulting from diffraction of order +1 or −1. When observed in reflection, the color effect will be symmetrical on either side of an illumination at normal incidence. It will be noted that a zeroth order color effect that is complementary to the color effect in transmission may be observed in reflection.

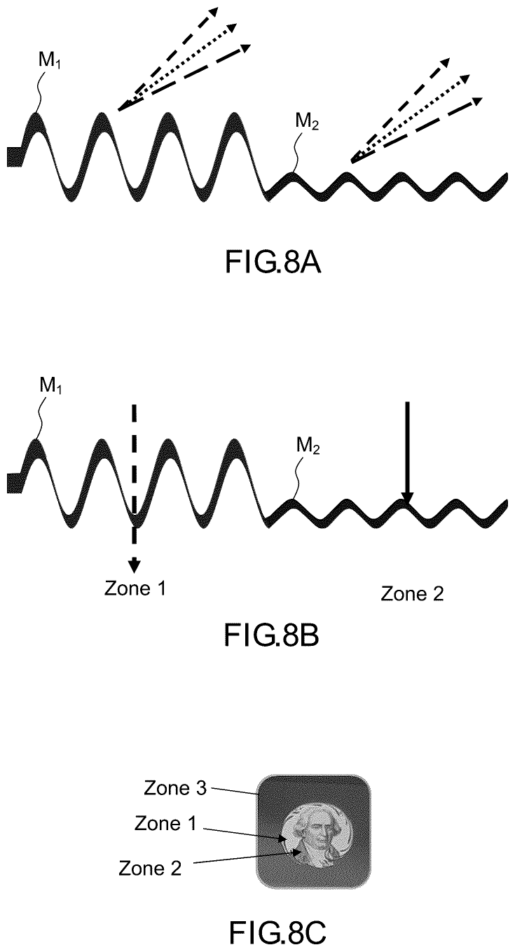

FIG. 8A and FIG. 8B illustrate a (partial) sectional view of another example of an optical security component according to the present description, which exhibits a noteworthy visual effect. In this example, the optical security component comprises a first diffractive structure S with, in first regions (“Zone 1”), a first pattern M₁ according to the present description and such as described for example with reference to FIG. 2, and in second regions (“Zone 2”), a second pattern M₂ forming a symmetrical one-dimensional periodic undulation with a pitch between about 400 nm and about 900 nm, and for example with a pitch identical to that of the undulations forming the first pattern M₁, but with a second depth smaller than the first depth of the first pattern M₁. As with the first pattern, the undulations of the second pattern are configured to form a diffraction grating defined so as to produce, after deposition of the metal layer, a diffractive effect in reflection of order 1 and of order −1 in a wavelength range between 400 nm and 700 nm. However, in this example, because of the shallower depth of the undulations, over a period of said first diffractive structure defined between two peaks, the thickness of the metal layer, even though it remains variable, has a minimum thickness strictly greater than 10 nm, such that the asymmetry in the distribution of the metal layer is no longer sufficient to generate the noteworthy effects in transmission described in relation to the first pattern M₁.

Thus, as illustrated in FIG. 8A, it will be possible to observe, in reflection, similar color effects resulting from diffraction in the first regions (“Zone 1”) and in the second regions (“Zone 2”). In contrast, as illustrated in FIG. 8B, transmittance will be zero or almost zero in the second regions (“Zone 2”) and strongly dependent on wavelength in the first regions (“Zone 1”) because of the noteworthy effects resulting from the asymmetry of the metal layer in the first pattern.

FIG. 8C illustrates, observed in transmission, an optical security component in which the diffractive structure is designed, in the phase of embossing of the embossing layer (113, FIG. 1A and FIG. 1B), to generate a high-definition image similar to the one illustrated in FIG. 6B. The diffractive structure comprises, in the example of FIG. 8C, a structure of the type schematically shown in FIG. 8A and FIG. 8B, with first regions (Zone 1) comprising the first pattern M₁, second regions (Zone 2) comprising the second pattern M₂, and, in this example, an unstructured third region (Zone 3). In the first regions structured with the pattern M₁, the optical security component appears colored with a color that depends, as explained above, on the first pattern, on the metal layer and on the tilt angle. In contrast, in the second regions comprising the second pattern M₂, the metal layer does not have sufficient asymmetry to generate a noteworthy effect and the transmission is zero or almost zero. The transmittance is also zero or almost zero in the unstructured regions (Zone 3). Thus, as illustrated in FIG. 8C, an observer sees, in transmission, a colored image with a bright and luminous color, and a very good definition. By varying the tilt angle about a direction Δ parallel to the direction of the undulations, a variation in the color in transmission is observed. As above, the color does not vary symmetrically on either side of normal incidence.

In reflection, the image is not visible since, if the pitch of the undulations of the first pattern is identical to the pitch of the undulations of the second pattern, the second regions diffract under the same conditions (wavelength as a function of tilt) as the first regions. Only the outline (Zone 3) stands out since, as this region is unstructured, it does not diffract.

Rapid variation in colors in an optical security component may advantageously be employed to generate original colored animations.

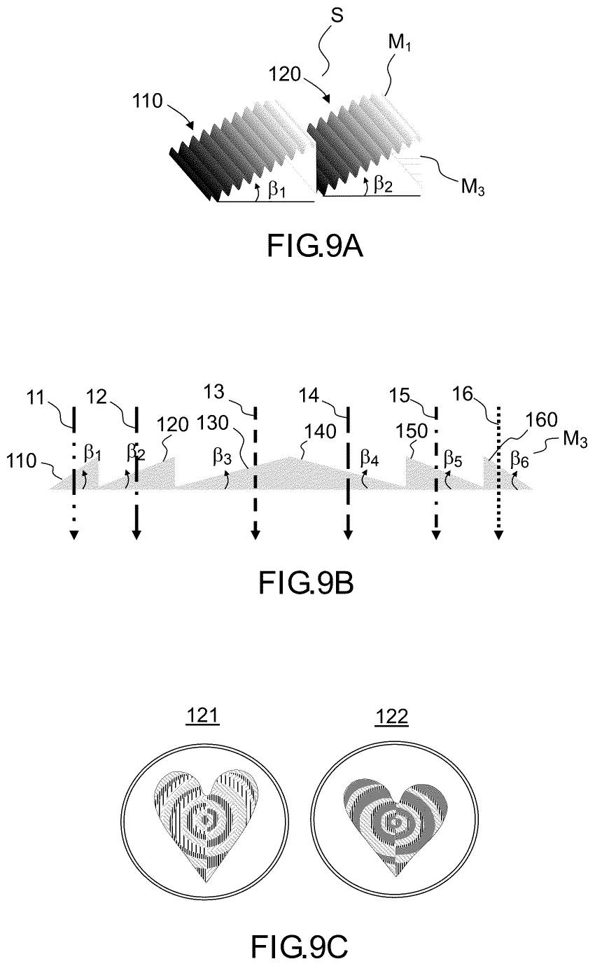

FIG. 9A shows a (partial) three-dimensional view of an optical security component comprising a first structure S with a first pattern M₁ according to the present description, the first pattern M₁ modulating a microscopic pattern M₃ made up of facets 110, 120 of microscopic dimensions. The facets are characterized by a slope (β₁, β₂ in the example of FIG. 9A). The slope of the facets is for example in a direction parallel to the direction of variation of the profile of the undulations of the first pattern.

For example, the facets have a dimension in the direction of their slope (or “width”) greater than or equal to about 4 times, and advantageously greater than or equal to about 8 times, the period of the grating formed by the constituent undulations of the first pattern M₁. The minimum dimension may therefore be chosen depending on the period of the undulations. For example, a minimum dimension of the width of the facets is equal to about 2 μm. According to one or more examples, the widths of the facets are between about 2 μm and about 100 μm, advantageously between about 2 μm and about 80 μm, advantageously about 4 μm and about 80 μm.

According to examples of embodiment, the facets have a substantially rectangular shape and have a “length” measured in a direction perpendicular to the direction of their slope. This length is for example less than about 100 μm.

According to one or more examples, all the facets have a substantially identical height, height being measured in a direction perpendicular to the plane of the component. The height of the facets is for example less than 2 microns, and advantageously less than 1 micron.

According to one or more examples, the facets of the set of facets have various heights. In this case however, the facets all have a maximum height. Said maximum height is for example less than 2 microns, and advantageously less than 1 micron.

According to one or more examples of embodiment, a maximum angular value of the slopes (in absolute value) is between about 7° and about 15°. By convention, in the present description, the positive direction when measuring the angular values of the slopes of the facets is the clockwise direction.

As illustrated in FIG. 9B, in examples of embodiment, at least some of the facets of the set of facets have different slopes, the variation in the slopes being increasing or decreasing in order to simulate a reflective element with a convex or concave region, respectively. In the present description, the visual effect resulting from such an arrangement of facets will be said to be a dynamic effect of “half-wave” type when the variation in the angular values of the slopes of the facets is increasing or decreasing and the angular values have the same sign. The visual effect resulting from such an arrangement of facets will be said to be a dynamic effect of “wave” type when the variation in the angular values of the slopes of the facets is increasing or decreasing and the arrangement is such that at least one change of sign is observed, as illustrated in FIG. 9B.

In reflection, because of the modulation of the facets by the first pattern M₁ in accordance with the present description, a dynamic effect of “wave” or “half-wave” type will be able to be seen by an observer, when the component is tilted, i.e. an effect such as a continuous scrolling of colored lines of light.

As illustrated in FIG. 9B, considering a set of facets 110, 120, 130, 140, 150, 160 having different slopes (respective slope angles of β₁, β₂, β₃, β₄, β₅, β₆), it will be possible to observe, in transmission, for incident light of normal incidence (incident perpendicular to the plane of the component), as many different colors as there are slopes, these different colors being represented, schematically, by the arrows 11, 12, 13, 14, 15, 16, respectively. Specifically, from the point of view of the incident light beam, the angle of the facet is equivalent to a non-zero incidence on the first pattern formed by the undulations.

FIG. 9C illustrates a colored animation visible in transmission for an optical security component in which the first pattern M₁ modulates a set of facets M₃ as described above.

When observing the optical security component in transmission, if the inclination of the component is changed by tilting it (rotation about an axis parallel to the direction of the undulations), a change in the color of each facet will be observed that will result in a movement of a colored line. It will be noted that because of the asymmetry of the colors as a function of the angle of incidence, the colors will be different depending on whether the component is tilted (rocked) in one direction (position 121) or in another (position 122).

It will be noted that the optical component according to the present description may comprise, in addition to the first structure in particular described by means of the preceding examples and in accordance with the present description, other structures (not shown in the figures). It may for example be a question of scattering structures, of holographic structures or of diffracting structures allowing so-called Alphagram® effects to be generated.

Moreover, partial demetallization (or local removal of the metal layer) using known methods is also possible, with a view to producing macroscopic patterns visible to the naked eye and providing an additional manner of authentication.

Examples of a process for manufacturing optical security components according to the present description will now be described.

A first step comprises designing said at least a first diffractive structure according to the embodiments described above, and any other structures.

Next comes a step of recording an original copy, also called an optical master. The optical master is for example an optical medium on which the one or more structures are formed. The optical master may be formed using electronic or optical lithography methods known in the art.

For example, according to a first embodiment, the optical master is produced by patterning a resist sensitive to electromagnetic radiation using an electron beam. In this example of embodiment, when the first pattern modulates a second pattern, the structure having the second pattern modulated by the first pattern may be patterned in a single step.

According to another embodiment, an optical lithography (or photolithography) technique may be used. In this example, the optical master is a sheet of photoresist and the step of producing it is carried out by exposing the sheet one or more times by projecting light through masks, such as phase-shift masks and/or amplitude masks, followed by development in a suitable chemical solution. For example, a first exposure is carried out by projecting light through amplitude masks the transmission coefficients of which are configured so that, after development, a relief corresponding to the first pattern is formed in regions where the first pattern is required. Next, a second blanket exposure is carried out using interference-photolithography methods known to those skilled in the art, the constituent undulations of the first pattern thus being recorded at least in the first regions where the first pattern is required. Similar steps may be employed to generate other reliefs, such as for example a second pattern in other regions. The order in which the patterns are formed is arbitrary and may be modified. Subsequently, the developing step is carried out. In this way, an optical master comprising at least the first structure with the first pattern is obtained after development.

As mentioned above, a step of transferring the optical master to metal may then be carried out, for example by electroplating, in order to obtain a metal master. According to one variant, a step of duplicating the metal master may be carried out in order to obtain a production tool of large size suitable for replicating the structure at industrial scale.

The manufacture of the optical security component then comprises a replicating step. For example, replication may be achieved by hot embossing the first layer 113 (FIGS. 1A, 1B) made of a dielectric material of refractive index n₁, which for example is a low-index layer, and typically an embossing lacquer of a few microns in thickness. The layer 113 is advantageously borne by the carrier film 111, which is for example a film of 10 μm to 50 μm thickness made of a polymer material, of PET (polyethylene terephthalate) for example. Replication may also be achieved by molding the layer of embossing lacquer before drying and then UV casting. Replication by UV casting in particular allows structures having a depth of large amplitude to be reproduced, and allows a higher fidelity replication to be obtained.

Generally, any other high-resolution replication method known in the art may be used in the replicating step.

Next comes deposition on the layer thus embossed of all the other layers, in particular the metal layer 114, then the (optional) layer 115 of dielectric material, the (optional) security layer 116 (which may be deposited uniformly or selectively to form a new pattern), and the adhesive or lacquer layer 117, 118 via a coating process.

As explained above, the metal layer is advantageously deposited by vacuum evaporation of metal with a non-zero angle to generate the desired asymmetry in the distribution of metal.

Alternatively, it is possible to carry out partial demetallization operations in order to obtain the desired asymmetry.

Moreover, optional steps known to those skilled in the art are possible, such as partial demetallization of the reflective layer 114 to form transparent regions having outlines of macroscopic dimensions that are visible to the naked eye.

Although described through a certain number of examples of embodiment, the optical security component according to the invention and the process for manufacturing said component comprise various variants, modifications and improvements that will appear obvious to those skilled in the art, and it will be understood that these various variants, modifications and improvements fall within the scope of the invention such as defined by the following claims.

### REFERENCES

Ref 1: US2010/0307705
Ref. 2: WO2012136777
Ref. 3: EP 2264491
Ref 4: M. T. Gale, “Zero-Order Grating Microstructures” in R. L. van Renesse, Optical Document Security, 2nd Ed., pp. 267-287
Ref. 5: Popov, Evgeny (2001). “Maxwell equations in Fourier space: fast-converging formulation for diffraction by arbitrary shaped, periodic, anisotropic media”. Journal of the Optical Society of America A. 18 (11): 2886-94. Bibcode:2001 JOSAA.18.2886P. doi:10.1364/JOSAA.18.002886

1. An optical security component for securing an object, for example a valuable document, for example an identity document or a banknote, configured for authentication in transmission, with the naked eye, the component comprising:
a first layer of dielectric material, which first layer is transparent in the visible;
at least a first diffractive structure patterned in said first layer;
a metal layer at least partially covering said first diffractive structure, and having a spectral band of reflection in the visible; and
wherein:
said first diffractive structure comprises, in a first region, at least a first pattern forming a first symmetrical one-dimensional periodic undulation having a first pitch between about 400 nm and about 900 nm, and a first depth, said first undulation being configured to form a diffraction grating producing, after deposition of the metal layer, a diffractive effect in reflection of order 1 and of order −1 in a wavelength range between 400 nm and 700 nm;
for each period of said first pattern, a period being defined between two extrema of the first undulation, the thickness of the metal layer, defined in a direction perpendicular to the plane of the component, is variable between a minimum value strictly less than 10 nm and a maximum value between about 10 nm and about 100 nm, and the metal is distributed asymmetrically, so as to produce a color effect visible in transmission.

2. The optical security component as claimed in claim 1, wherein said first pitch is between about 500 nm and about 700 nm.

3. The optical security component as claimed in claim 1, wherein said first diffractive structure comprises, in a second region, at least a second pattern forming a second symmetrical one-dimensional periodic undulation having a direction of variation of its profile parallel to the direction of variation of the profile of the first undulation, having a depth identical to that of the first undulation and having a pitch different from that of the first undulation, the first pattern and second pattern having outlines that are recognizable when observed with the naked eye, in transmission.

4. The optical security component as claimed in claim 1, wherein said first diffractive structure comprises, in a second region, at least a second pattern forming a second symmetrical one-dimensional periodic undulation having a direction of variation of its profile parallel to the direction of variation of the profile of the first undulation, having a pitch identical to that of the first undulation and having a second depth strictly less than the first depth of the first undulation, the first pattern and second pattern having outlines that are recognizable when observed with the naked eye, in transmission.

5. The optical security component as claimed in claim 1, wherein said metal layer results from evaporation of metal onto said first structure with a non-zero evaporation angle, for example an evaporation angle between about 25° and about 70°.

6. The optical security component as claimed in claim 1, wherein said first diffractive structure further comprises a microscopic pattern comprising a set of facets of microscopic dimensions, and of variable slopes, the first pattern modulating the microscopic pattern.

7. The optical security component as claimed in claim 1, further comprising at least a second structure patterned in said first layer, said second structure for example being chosen from: a scattering structure, a holographic structure, a diffracting structure of Alphagram® type.

8. A secure object, for example a valuable security document, comprising a substrate and an optical security component as claimed in claim 1, deposited on said substrate.

9. A process for manufacturing an optical security component for securing an object, for example a valuable document, for example an identity document or a banknote, configured for authentication in transmission, with the naked eye, the process comprising:
depositing a first layer of dielectric material on a carrier film, the first layer being transparent in the visible;
forming at least a first diffractive structure on said first layer,
depositing a metal layer at least partially covering said first diffractive structure, and having a spectral band of reflection in the visible,
wherein:
said first diffractive structure comprises, in a first region, at least a first pattern forming a first symmetrical one-dimensional periodic undulation having a first pitch between about 400 nm and about 900 nm, and a first depth, said first undulation being configured to form a diffraction grating producing, after deposition of the metal layer, a diffractive effect in reflection of order 1 and of order −1 in a wavelength range between 400 nm and 700 nm;
for each period of said first pattern, a period being defined between two extrema of the first undulation, the thickness of the metal layer, defined in a direction perpendicular to the plane of the component, is variable between a minimum value strictly less than 10 nm and a maximum value between about 10 nm and about 100 nm, and the metal is distributed asymmetrically, so as to produce a color effect visible in transmission.

10. The process for manufacturing an optical security component as claimed in claim 9, wherein said metal layer results from evaporation of metal onto said first structure with a non-zero evaporation angle, for example an evaporation angle between about 25° and about 70°.
